(19) United States
(12) Patent Application Publication
(10) Pub. No.: US 2011/0189356 A1
(43) Pub. Date: Aug. 4, 2011

(54) Methods of Storing Cheese

(75) Inventor: Barbara B. Hanley, Westport Point, MA (US)

(73) Assignee: Shy Brothers Farm, Westport Point, MA (US)

(21) Appl. No.: 12/696,473

(22) Filed: Jan. 29, 2010

(51) Int. Cl. B65D 85/76; A23C 19/16; B65D 81/24

(52) U.S. Cl. 426/130; 426/415

(57) ABSTRACT

One aspect of the present invention relates to a package for respiring foodstuffs, such as bloomy rind cheese products, with improved shelf life. In certain embodiments the package comprises a bloomy rind cheese enclosed in thermoplastic film having a carbon dioxide transmission rate of about 10,000 cc/100 sq.in/day, oxygen transmission rate of about 1,100 cc/100 sq.in/day, and water vapor transmission rate of about 26.6 g/100 sq.in/day at 100 F/90% RH. In certain embodiments the package comprises a bloomy rind cheese enclosed in thermoplastic film having a carbon dioxide transmission rate of about 8,240 cc/100 sq.in/day, oxygen transmission rate of about 1,030 cc/100 sq.in/day, and water vapor transmission rate of about 19.1 g/100 sq.in/day at 100 F/90% RH. The present invention also relates to a method for wrapping a respiring food product with a thermoplastic film having a carbon dioxide transmission rate of about 10,000 cc/100 sq.in/day, oxygen transmission rate of about 1,100 cc/100 sq.in/day, and water vapor transmission rate of about 26.6 g/100 sq.in/day at 100 F/90% RH. The present invention also relates to a method for wrapping a respiring food product with a thermoplastic film having a carbon dioxide transmission rate of about 8,240 cc/100 sq.in/day, oxygen transmission rate of about 1,030 cc/100 sq.in/day, and water vapor transmission rate of about 19.1 g/100 sq.in/day at 100 F/90% RH.

### BACKGROUND OF THE INVENTION

Many foods and some drinks are packaged in any of a wide variety of films suitable for retaining their freshness, tastiness, nutrient value, and other desirable properties for as long as possible. Respiring food products, such as natural cheeses, present certain packaging challenges. These packaging challenges spring from the storage and shipping requirements of respiring food products, and the processes by which they are made.

In forming natural cheeses, specific molds or bacteria may be added just prior to or during ripening to produce varieties of cheeses having different characteristics, such as flavor, aroma, texture, and appearance. For example, blue cheeses are made by inserting a blue green mold, Penicillium roqueforti or Penicillium glaucum, into the interior of the cheese. Cheeses such as brick and limburger are ripened by bacteria which are coated on the surface of the cheese. The original starter culture bacteria also may provide distinctive characteristics for ripening. Bacteria added in the starter culture are used for ripening in production of hard and semi-hard cheeses, such as parmesan, cheddar and gouda. Swiss-type cheeses may also be ripened using the original starter culture, but typically additional bacteria, such as Propionibacter Shermanii, are added. In emmental or Swiss-type cheeses the “eyes” are formed by gas pockets of carbon dioxide (CO₂) given off in large amounts by those bacteria.

The exterior surfaces of so-called “bloomy rind” cheeses (also known as “surface-ripened” cheeses) are coated with live microorganisms. Surface-ripened cheeses, such as camembert and brie, have an exterior surface coat of white mold, such as Penicillium camembert and Geotrichum Candidum, respectively. The microorganisms on the surface of the cheese require specific equilibrium environmental conditions, such as the gas composition and moisture level of the surrounding atmosphere. A lack of oxygen or excess humidity can destroy this equilibrium and deteriorate the product very quickly. An appropriate environment is critical not only for aesthetic reasons, as it impacts the color and texture to the rind, but more importantly for the development of the characteristic flavors of the bloomy rind cheeses.

Bloomy rind cheeses must undergo curing and surface-mold-growth finishing, which are sensitive processes requiring environments that encourage growth of the specific molds. When the process reaches the desired stage, mold growth is slowed by lowering the temperature. The mold continues to grow slowly, however, and as a live organism must continue to respire, albeit at a lower rate. Therefore, finishing processes continue after the manufacture and packaging of the cheese (i.e., during distribution, the storage period before sale, and in consumers' refrigerators). During curing the surface mold grows and the cheese absorbs oxygen from the environment; and it also emits moisture and gases, in particular carbon dioxide. Packaging films which have low permeability to CO₂ are subject to “pillowing” when hermetically sealed around a respiring article. “Pillowing” will occur if the respiration rate of the enclosed article exceeds the CO₂ transmission rate for the enclosing film. Pillowing (also known as “ballooning”) refers to the inflation of the sealed film, which typically causes the film surface to move away from and out of contact with much of the surface of the enclosed article. Unfortunately, some consumers mistakenly view pillowing as a defect in packaging or an indication of spoilage, and avoid purchase of refrigerated foodstuffs having a pillowed container. Furthermore, retention of high concentrations of CO₂ about a respiring foodstuff may adversely affect the curing process, possibly delaying development of certain desirable characteristics (e.g., full flavor and aroma) resulting from the active microbiological processes.

Bloomy rind cheeses cannot be packaged with trapped humidity because it will form condensate with a temperature change. Condensate will prevent the surface mold from properly respiring. Surface mold that cannot breathe dies due to lack of oxygen, putting off ammonia and other distasteful byproducts. Successful packaging will not trap humidity in the typical food stocking environment of 38 to 40 F.

Additionally, packaged natural cheese products, such as bloomy rind cheeses, require atmospheric oxygen (O₂) during transportation, shipping, and storage. However, a high oxygen transmission rate may allow the cheese to dry out, changing its character. Consequently, if the oxygen transmission rate of a packaging film is too great, then the shelf life of the packaged cheese is relatively short. Shorter product life affects the financial aspects of the product, obviously. The material in which the cheese is packed has to possess, therefore, a certain balance of permeability to moisture and gases in order to permit controlled absorption and removal thereof, whereby a desirable finishing process of the cheese can take place.

The inherent challenges associated with packaging respiring food products, such as bloomy rind cheeses, must be addressed by utilizing film structures and packages which deal with these problems in a cost-effective manner. These film structures and packages not only need to possess high gas transmission rates but also the ability to maintain the humidity in the package within a certain range. When the humidity level in the package is too low, a cheese product tends to dry out. On the other hand, if the humidity level is too high, a cheese deteriorates quickly. Further, the oxygen transmission rate of the packaging material should be as low as possible to keep the oxygen tension inside the wrap at a low level, thus preventing mold growth. In contrast, the carbon dioxide transmission rate should be as high as possible to allow for escape of the carbon dioxide produced during curing.

Favorable CO₂/O₂ transmission rates, and their ratio, for a packaging material will allow surface-ripened cheese to breathe without drying out in the package. In addition, a suitable film provides a moisture barrier and structural integrity (e.g., stiffness and crack resistance). However, the film and overall packaging must be cost-effective. In sum, appropriate packaging materials offer the following performance features: a high barrier to oxygen, steam and flavorings, which increases the shelf life of the packaged product; good mechanical characteristics, so that the contents are protected during transport and can be packaged with automatic machinery; optical characteristics of transparency and gloss, so that the appearance of the product does not deteriorate and attractive packs are obtained; easy sealing to close the wrapping and good strength of said welding; and good adherence of the wrapping to the contents.

Various monolayer and multilayer thermoplastic films have been used for packaging cheeses. Three to five layer films are common. Typical structures include: EVA/PVDC/EVA, EVA/EVA/PVDC/EVA, Ionomer/EVA/PVDC/EVA, and variations thereof in which ethylene-based polymers are blended into one or more of the EVA layers. Some cheese packaging films are heat shrinkable at 90° C. Some of the nonshrinking films have an oxygen barrier comprising one or more layers of nylon or EVOH or a blend of EVOH with nylon. Other nonshrinking films include structures of the type EVA:PE/Nylon, EVA: PE/Nylon/EVOH/Nylon/EVA:PE, EVA:PE/PVDC/Nylon, EVA: PE/EVOH/Nylon, and EVA:PE/Nylon/EVA. The known nonshrinking EVOH-containing films generally have a relatively thick EVOH-containing layer (e.g., generally greater than 0.5 mm (12.7 microns)). Unfortunately, all of the EVOH-containing high permeable cheese films have disadvantages for packaging respiring cheeses, including one or more of the following: undesirably low shrink values particularly at low temperatures (e.g., 90° C. or less); an undesirably narrow heat sealing range; use of expensive resins such as ionomers in the other layers; and poor optical properties, such as high haze, low gloss and/or streaks or lines which detract from the film's appearance. Furthermore, known EVOH-containing cheese films have a disadvantageously thick EVOH-containing layer that is difficult to process into an oriented film or make into a heat shrinkable film having high shrinkage values and shrink forces. For example, the higher CO₂ transmission rates associated with PVDC-containing films require that the PVDC layer be heavily plasticized to achieve optimal gas transmission rates. Such plasticizers may adversely affect other film properties including processability, optical properties, and orientability. Also, recycling of PVDC polymers is difficult, particularly where the waste polymer is mixed with other polymers having different melting points. Attempts to remelt film containing PVDC frequently result in degradation of the PVDC component.

Most conventional packaging materials are nontransparent laminates of oiled paper with various additional layers of paper, aluminum foil paper, polypropylene, and cellophane. Other packaging materials and coatings in use for packaging cheeses include fats, cloths, waxes, metal foils, and plastic films and sheets. The required transmission rate is typically available because such packing materials are folded loosely around the cheese, thereby permitting moisture and gases to escape through gaps between the folds. For many years waxes and resins have also been used to coat dry, hard or semi-hard cheeses, such as cheddar, cheshire, gouda, edam, and danbo. Alternatively, conventional packing materials may be provided with small holes, allowing the package to “breathe.” Typically, bloomy rind cheeses are packaged in cellulose, OPP foil overwrap, or formaticum; further, they are often enclosed in a wooden or cardboard box.

Unfortunately, all of the aforementioned packaging materials have drawbacks because they do not allow for optimal moisture and gas exchange. The shortcomings of these films may be mitigated by opening slightly the ends of the cheese package. However, this approach also removes the physical, moisture, and oxygen barrier at the ends, thereby subjecting the enclosed cheese to the deleterious effects of atmospheric oxygen, loss of moisture, and direct exposure to the environment. Conventional packaging materials are also flawed due to their opacity, which encourages tampering to view their contents. Finally, many of the packaging materials are relatively expensive; for example, formaticum is roughly fifteen times more expensive than conventional cheese packaging materials.

In sum, many different multilayer film structures have been and continue to be used to package cheeses. These structures all suffer from various disadvantages, especially with respect to packaging respiring cheeses. Consequently, there is a need in the cheese-packaging industry for alternative packaging materials that do not have these drawbacks.

### SUMMARY OF THE INVENTION

One aspect of the invention relates to a package, comprising a bloomy rind cheese; and a thermoplastic film; wherein said cheese is enclosed in said film; and said film has a carbon dioxide transmission rate from about 7,500 cc/100 sq.in/day to about 11,000 cc/100 sq.in/day. Another aspect of the invention relates to a package, comprising a bloomy rind cheese; and a thermoplastic film; wherein said cheese is enclosed in said film; and said film has an oxygen transmission rate from about 900 cc/100 sq.in/day to about 1,300 cc/100 sq.in/day. Another aspect of the invention relates to a package, comprising a bloomy rind cheese; and a thermoplastic film; wherein said cheese is enclosed in said film; and said film has a water vapor transmission rate from about 17 g/100 sq.in/day at 100 F/90% RH to about 30 g/100 sq.in/day at 100 F/90% RH. In certain embodiments, an aforementioned film has an oxygen transmission rate of about 1,030 cc/100 sq.in/day or about 1,100 cc/100 sq.in/day. In certain embodiments, an aforementioned film has a water vapor transmission rate of about 19.1 g/100 sq.in/day at 100 F/90% RH or about 26.6 g/100 sq.in/day at 100 F/90% RH. In certain embodiments, an aforementioned film has a carbon dioxide transmission rate of about 8,240 cc/100 sq.in/day or about 10,000 cc/100 sq.in/day. In certain embodiments, an aforementioned film is 60 gauge. In certain embodiments, an aforementioned film is 65 gauge. In certain embodiments, an aforementioned film is non-perforated. In certain embodiments, said bloomy rind cheese is selected from the group consisting of brie, Brillat-Savarin Petit, Triple-crème, chaource, coulommiers, fromage, Pierre Robert, and camembert.

In certain embodiments, the thermoplastic film may be 60 gauge having a carbon dioxide transmission rate of about 10,000 cc/100 sq.in/day, oxygen transmission rate of about 1,100 cc/100 sq.in/day, and water vapor transmission rate of about 26.6 g/100 sq.in/day at 100 F/90% RH. In certain embodiments, the thermoplastic film may be 65 gauge having a carbon dioxide transmission rate of about 8,240 cc/100 sq.in/day, oxygen transmission rate of about 1,030 cc/100 sq.in/day, and water vapor transmission rate of about 19.1 g/100 sq.in/day at 100 F/90% RH.

Another aspect of the invention relates to a method of packaging a respiring food product, comprising wrapping said respiring food product with any one of the aformentioned thermoplastic films. In certain embodiments, said respiring food product is selected from the group consisting of processed meat, fresh meat, fish, natural cheese, vegetable, and fruit. In certain embodiments, said respiring food product is natural cheese; and said natural cheese is selected from the group consisting of mold-ripened cheese, bloomy rind cheese, white mold rind cheese, emmental cheese, Jarlsberg, edamer cheese, butterkase cheese, gouda, swiss, edam, camembert, brie, triple-crème, Brillat-Savarin, Pierre Robert, chaource, coulommiers, fromage, hard-grating, parmesan, hard cheese, appenzeller, cheddar, semisoft cheese, munster, roquefort, limburger, soft-ripened, cottage cheese, washed rind cheeses, blue cheese, Vacherin du Haut-Doubs cheese, Chèvre-Boîte, stilton, gorgonzola, gruyere, herregaardsost, danbo, asiago, viereckhartkase, bergkase, samsoe, cheshire, maribo, svecia, manchego, provolone, fontina, raclette, trappist, tilsit, havarti, cantal, St. Paulin, and feta. In certain embodiments, said respiring food product is a bloomy rind cheese. In certain embodiments, said respiring food product is a bloomy rind cheese; and said bloomy rind cheese is selected from the group consisting of brie, Brillat-Savarin Petit, Triple-crème, chaource, coulommiers, fromage, Pierre Robert, and camembert.

### DETAILED DESCRIPTION OF THE INVENTION

One aspect of the invention relates to a method of packaging a respiring food product, such as a natural cheese, which comprises enclosing said respiring food product in a thermoplastic film having a carbon dioxide transmission rate from about 7,500 cc/100 sq.in/day to about 11,000 cc/100 sq.in/day. Another aspect of the invention relates to a method of packaging a respiring food product, such as a natural cheese, which comprises enclosing said respiring food product in a thermoplastic film having a water vapor transmission rates from about 17 g/100 sq.in/day at 100 F/90% RH to about 30 g/100 sq.in/day at 100 F/90% RH. Another aspect of the invention relates to a method of packaging a respiring food product, such as a natural cheese, which comprises enclosing said respiring food product in a thermoplastic film having a oxygen transmission rate from about 900 cc/100 sq.in/day to about 1,300 cc/100 sq.in/day. Another aspect of the present invention provides a sealed package for bloomy rind cheeses, which increases the shelf life of such cheeses. The package may be characterized by a thermoplastic film, having high gas transmission rates, that allows gaseous exchange with the outer atmosphere, and encasing the bloomy rind cheese. The thermoplastic film may be characterized by a desirable combination of properties: relatively low transmission rates to oxygen and water vapor, particularly in combination with higher CO₂ transmission rates; controlled transmission rates to carbon dioxide without perforations in the film; resistance to degradation by food acids, salts and fat; high shrinkage values at low temperatures (90° C. or lower); residual shrink force which maintains a low level of oxygen contact with the food surface after opening; good heat sealability especially over a broad voltage range on commercial sealers; low levels of extractables with compliance with governmental regulations for food contact; delamination resistance and can be oriented without requiring addition of processing aids or plasticizers; good mechanical strength; chlorine-free construction; low haze; high gloss; high clarity; easy to remove from an enclosed foodstuff, such as cheese; does not impart off tastes or odors to packaged food; good tensile strength; a surface which is printable; and good machinability.

One aspect of the present invention relates to a package for bloomy rind cheese which increases the shelf life of such products. The package may be characterized by high gas and low water transmission rates, which are suitable for packaged goods which evolve gases, as they mature, such as cheese. Another aspect of the present invention relates to a method of packaging cheese using a thermoplastic film such that the organoleptic and physical properties of the cheese are maintained.

In one embodiment of the present invention, the packaged cheese product permits the curing, transporting, and storing of bloomy rind cheese products by having a high CO₂ transmission rate while maintaining a low O₂ transmission rate and low water vapor transmission. This combination of properties provides a longer shelf life (up to 6 months) for the cheese stored in the packages, as well as an aesthetically pleasing package due to elimination or reduction of pillowing.

In one embodiment of the present invention, the thermoplastic films have an oxygen transmission rate of about 1,030 cc/100 sq.in/day or about 1,100 cc/100 sq.in/day. In another embodiment of the present invention, the thermoplastic films have a carbon dioxide transmission rate of about 8,240 cc/100 sq.in/day or about 10,000 cc/100 sq.in/day. O₂ and CO₂ transmission rates may be measured using the analytical technique ASTM D 3985. In yet another embodiment of the present invention, the thermoplastic films have water vapor transmission rates of about 19.1 g/100 sq.in/day at 100 F/90% RH or about 26.6 g/100 sq.in/day at 100 F/90% RH, as measured by, e.g., ASTM E01434, MOCON-RT)(23° or F-1249 methods. The reduced water-vapor transmission rate results in reduced loss in weight from a product packaged therein. Transmission rates substantially higher than the above indicated higher limit are disadvantageous in that they can result in a dried cheese of poor quality. Transmission rates substantially lower than the above indicated lower limit are disadvantageous in that they can result in rapid deterioration of the cheese.

In one embodiment of the present invention, the thermoplastic films provide a packaging material which is characterized by a relatively low oxygen transmission rate (i.e., good oxygen barrier) and a relatively high carbon dioxide transmission rate.

In another embodiment of the present invention, the ratio of CO₂ transmission rate to O₂ transmission rate is in the range of about 6:1 to about 10:1. In one embodiment of the present invention, the ratio of CO₂ transmission rate to O₂ transmission rate is about 8:1 or about 9:1.

In one aspect of the invention, a desirable high CO₂ transmission rate and low O₂ transmission rate are achieved by using a packaging film structure that is non-perforated and having a thickness of 60 gauge or 65 gauge. However, a high CO₂ transmission rate and a low O₂ transmission rate may be obtained without perforations.

In another aspect of the present invention, the package is characterized by a thermoplastic film having a thickness of 60 gauge or 65 gauge, non-perforated, and available from Pliant Corporation with product data specifications for a 60 gauge and 65 gauge film as shown in Table 1 and Table 2, respectively.

TABLE 1
Technical specifications for a 60 gauge film

| | | ASTM | | |
|---|---|---|---|---|
| Property | | Method | Units | Values |
| Gauge | | D-2103 | mils | 0.60 |
| Yield | | FPA B-11 | sq inches/pound | 37,200 |
| Gloss 45° | | D-2457 | Percent | |
| | | | Percent | |
| Haze | | D-1003 | Percent | 0.7 |
| Light Transmittance | | D-1003 | Percent | |
| COF | | D-1894 | | |
| Tensile, Ultimate | MD | D-882 | psi | 5,700 |
| | TD | | psi | 3,300 |
| Elongation Ultimate | MD | D-882 | Percent | 275 |
| | TD | | Percent | 200 |
| 1% Secant Modulus | MD | D-882 | psi | |
| | TD | | psi | |
| MVTR | | F-1249 | g/100 sq in/day @ | 26.6 |
| | | | 100 F./90% rh | |
| OTR | | D-3985 | cc/100 sq in/day @ | 1100 |
| | | | 73 F./0% rh | |
| Dart Impact | | D-1709 | grm/mil | 45 |
| Carbon Dioxide | | D3985 | cc/100 sq. in/24 hrs. | 10,000 |
| Heat Seal Range | | [symbol] kco Sea [symbol] | 31 psi, 3.0 sec. | 290° F. |
| Heat Seal Range | | | | 325° F. |

[symbol]

indicates data missing or illegible when filed

TABLE 2
Technical specifications for a 65 gauge film

| | | ASTM | | |
|---|---|---|---|---|
| Property | | Method | Units | Values |
| Gauge | | D-2103 | mils | 0.65 |
| Yield | | FPA B-11 | sq inches/pound | 34,300 |
| Gloss 45° | | D-2457 | Percent | |
| | | | Percent | |
| Haze | | D-1003 | Percent | 0.59 |
| Light Transmittance | | D-1003 | Percent | |
| COF | | D-1894 | | |
| Tensile, Ultimate | MD | D-882 | psi | 4,928 |
| | TD | | psi | 5,012 |
| Elongation Ultimate | MD | D-882 | Percent | 260 |
| | TD | | Percent | 319 |
| 1% Secant Modulus | MD | D-882 | psi | |
| | TD | | psi | |
| MVTR | | F-1249 | g/100 sq in/day @ | 19.1 |
| | | | 100 F./90% rh | |
| OTR | | D-3985 | cc/100 sq in/day @ | 1030 |
| | | | 73 F./0% rh | |
| Dart Impact | | D-1709 | grm/mil | 70+ |
| Carbon Dioxide | | D3985 | cc/100 sw. in₁/24 hrs. | 8,240 |
| Heat Seal Range | | [symbol] aler 31 p [symbol] | Degrees F. | 330-360° F. |

[symbol]

indicates data missing or illegible when filed

In another embodiment of the present invention, the thermoplastic film has a shrink feature, i.e., the propensity of the film upon exposure to heat to shrink or, if restrained, create shrink tension within the packaging film. This property is imparted to the film by orientation of the film during its manufacture. Typically, the manufactured film is heated to an orientation temperature and then stretched either in a longitudinal (machine) direction, a transverse direction, or both, in varying degrees to impart a certain degree of shrinkability in the film upon subsequent heating. After being so stretched, the film is rapidly cooled to provide this latent shrinkability to the resulting film. One advantage of shrinkable film is the tight, smooth appearance of the wrapped product that results, providing an aesthetic package as well as protecting the packaged product from environmental abuse.

In another embodiment of the present invention, the package is characterized by a combination of high abuse resistance and high tensile strength. This combination of properties provides adequate physical protection for the packaged item during storage and distribution, as well as the necessary shelf life. In one embodiment of the present invention, the package may be characterized by a high tensile strength of about 5,700 psi MD measured by ASTM D 882-90 and about 3,300 psi TD measured by ASTM Method A. In another embodiment of the present invention, the package may be characterized by a high tensile strength of about 4928 psi MD measured by ASTM D 882-90 and about 5012 psi TD measured by ASTM Method A. In another embodiment of the present invention, the thermoplastic films have an abuse resistance to elongation at break in the range of about 200% to about 275%. In another embodiment of the present invention, the thermoplastic films have an abuse resistance to elongation at break in the range of about 260% to about 319%.

In one aspect of the present invention, the thermoplastic film has at least 20% (more about 30% or higher) shrinkage values in at least one direction and two directions at 90° C. or less. In another aspect of the present invention, the thermoplastic films are heat sealable over a broad voltage range, and heat shrinkable at low temperatures in combination with such broad range heat sealability. In one embodiment of the present invention, the thermoplastic films may have a heat seal range of about 290° F. to about 325° F. In another embodiment of the present invention, the thermoplastic films may have a heat seal range of about 330° F. to about 360° F.

In one embodiment of the present invention, the thermoplastic films are oriented either monoaxially or biaxially, and used as a shrink film. Optionally, the oriented film may be further processed by reheating the film to a temperature near its orientation temperature, i.e., either somewhat below, at, or somewhat above its orientation temperature, to heat set the film. This future processing step has the advantage of substantially retaining many of the favorable physical characteristics of an oriented film, such as higher modulus and improved optical properties, while providing a substantial shrink-free film in applications where a shrink feature is undesirable.

In another embodiment of the present invention, the thermoplastic film provides mechanical strength, abrasion and abuse resistance and resists burn through during heat sealing. This outer layer may be sufficiently thick to provide support and impart strength to the packaging film wall in order to withstand the shrinking operation, handling pressures, abrasion, and packaging with a foodstuff such as cheese. The outer layer may comprise a polyethylene or an ethylene homopolymer or a copolymer of ethylene with a minor proportion of one or more alpha-olefins, which may provide a water vapor barrier which resists moisture permeation. High moisture barrier properties are desirable to avoid weight loss and undesirable drying of the cheese which may deleteriously affect the desired cheese sensory properties including texture, mouth feel, taste, and appearance.

In one embodiment of the present invention, the methods are suitable for the packaging of slices of bloomy rind cheese or of whole cheese products. While the present invention has been described for use in the packaging of bloomy rind cheeses, the methods of the present invention can also be employed for the packaging of a number of other cheeses which are exemplified by but not limited to mold-ripened cheese, bloomy rind cheese, white mold rind cheese, emmental cheese, Jarlsberg, edamer cheese, butterkase cheese, gouda, swiss, edam, camembert, brie, triple-creme, Brillat-Savarin, Pierre Robert, chaource, coulommiers, fromage, hard-grating, parmesan, hard cheese, appenzeller, cheddar, semisoft cheese, munster, roquefort, limburger, soft-ripened, cottage cheese, washed rind cheeses, blue cheese, Vacherin du Haut-Doubs cheese, Chèvre-Boîte, stilton, gorgonzola, gruyere, herregaardsost, danbo, asiago, viereckhartkase, bergkase, samsoe, cheshire, maribo, svecia, manchego, provolone, fontina, raclette, trappist, tilsit, havarti, cantal, St. Paulin, and feta.

In another embodiment of the present invention, the methods of packaging cheese may be advantageously employed to package other respiring food products, for example, meats, fruits, fishes, vegetables, or flowers.

In one aspect of the present invention, the thermoplastic film provides a high stiffness to the package as is required in order to guarantee machinability and sufficient resistance of the package during manipulation and transportation. Moreover, the film may provide good machinability and facilitates passage of the film over equipment (e.g., for inserting foodstuffs such as cheese). This packaging may be produced on either horizontal or vertical automatic packaging, semi-automatic packaging, or hand wrapping machines with the aid of the films of the invention.

In one aspect of the present invention, the thermoplastic film can be a monolayer film or a multilayer film. In another aspect of the present invention, the thermoplastic film is used by wrapping it around the food article, in particular a bloomy rind cheese, and closing the package by sealing the laminate film. This latter can be trim, heat or bunch sealed.

In one embodiment of the present invention, the thermoplastic films can be modified with a sealing layer while not subtracting from the permeability of the whole laminate. The sealing layer can be selected from high permeability and sealable polyolefins like polybutylene and higher polyolefins. The outer sealing layers may be ethylene-vinylacetate (EVA) copolymers with a vinylacetate content of about 8 to 28% by weight of the EVA and a MFI of about 0.5 to 7, and the ethylene copolymers known as Very Low Density Linear Polyethylenes (VLDPE) as described in Plastics Technology, September 1984, page 113 and October 1984, page 13 as well as in a company brochure published in February 1984 by DSM in the Netherlands entitled “Stamilex PE”. About 10 to 20% by weight of such VLDPE comprises an olefin comonomer, chosen from C4-, C6- and CB-alpha-n-olefins which have a MFI of 0.5 to 8.0.

In another embodiment of the present invention, the sealing layers contribute to, or at least do not impair, the high water vapor and gas transmission rates of the core layer, while also providing a desirable abuse resistance (resistance to puncture, tear, etc.) property.

In one embodiment of the present invention, the thermoplastic films may have an abuse resistance to dart impact of between about 45 grm/mil and about 70 grm/mil as measured using the ASTM D-1709 method.

In one aspect of the present invention, the thermoplastic films may be treated with additional layers, polymers, processing aids, antifogging, antioxidants, fillers, antiblock, slip agents, or other conventional manufacturing or handling aids pigments, compatibilizers to add or modify various properties of the desired film such as heat sealability, interlayer adhesion, food surface adhesion, shrinkability, shrink force, wrinkle resistance, puncture resistance, printability, toughness, gas or water barrier properties, abrasion resistance and optical properties such as gloss, haze, freedom from lines, streaks or gels, provided the addition of these materials does not change the essence of the invention.

In one aspect of the present invention, the thermoplastic films may have a haze property of between about 0.59% and about 0.7%.

In another aspect of the present invention, the thermoplastic film may include an abuse resistance layer. This can be made, as known in the art, from a single resin or a blend of resins selected to provide the overall structure with the desired puncture, wear, and abuse resistance characteristics. Typical resins that can be used in the outer abuse resistance layer are e.g., polyolefins, ethylene-vinyl acetate polymers, ethylene-alkyl acrylate or methacrylate polymers, ethylene homo-polymers, ethylene-alpha-olefin polymers, etc. The resins can be additives as known in the art in order to improve the properties of the film or the manufacturing properties thereof. The resins may contain stabilizers, anti-oxidants, pigments, and U.V. absorbers. The outer layers may comprise slip and anti-blocking agents as conventionally used in this field.

In one embodiment of the present invention, the method of packaging cheeses can be used in combination with supports and absorbent agents. Typical supports suitable for use in the invention may be made of mono-layer or multi-layer thermoplastic materials either foamed or solid. Suitable multi-layer thermoplastic material may comprise at least one substrate layer and one heat-sealable surface layer. The substrate layer may be of foamed polypropylene, foamed polystyrene, or foamed polyester. Alternatively the substrate layer may be solid polystyrene, polyester, polypropylene, polyethylene, polyamide and the like. The heat-sealable surface layer may comprise ethylene homo- and co-polymers, propylene homo- and co-polymers, ionomers and the like as well as blends of these polymers in any proportions. Other blends for the heat-sealable layer may also include peelable blends. Additional layers can be present in the multi-layer structure, such as tie or adhesive layers, bulk layers and the like.

In another embodiment of the present invention, the thickness of the support may comprise between 100 and 3,000 μm or between 300 and 1,000 μm. The supports can be in the form of trays, with a bottom wall and upwardly extending side-walls. The support may exceed the size of the cheese product not only in the horizontal dimensions but also in the vertical one, i.e., the height, to avoid direct contact between the surface of the cheese product and the thermoplastic film in the final package.

In one aspect of the present invention, the moisture absorbent agent may comprise at least two components: an inorganic salt selected from the group of NaCl, KCl and CaCl₂ and a super-absorbent polymer. The moisture absorbent agent may keep the humidity level in the package within an optimal range. The inorganic salt component may regulate the humidity level in the package, whereas the super-absorbent polymer may capture the liquid that forms as a consequence of the inorganic salt activity.

In one embodiment of the present invention, suitable polymers for the thermoplastic films may include ethylene homo- and copolymers, poly(vinylalcohol), styrene butadiene block copolymers, especially styrene ethylene butadiene block copolymers, and the like. Ethylene homopolymers include high density polyethylene (HDPE), low density polyethylene (LDPE), linear low density polyethylene (LLDPE), very low density polyethylene (VLDPE), and ultra-low density polyethylene (ULDPE). Ethylene copolymers may include ethylene/alpha-olefin copolymers and ethylene/unsaturated ester copolymers. Ethylene/alpha-olefin copolymers may include copolymers of ethylene and one or more comonomers selected from C₃-C₂₀ alpha-olefins, such as 1-butene, 1-pentene, 1-hexene, 1-octene, 4-methyl-1-pentene and the like. Ethylene/alpha-olefin copolymers may have a density in the range of from about 0.86 to about 0.94 g/cm³. Linear low density polyethylene (LLDPE) may include ethylene/alpha-olefin copolymers which fall into the density range of about 0.915 to about 0.94 g/cm³. Ethylene copolymers may be ethylene/butyl acrylate copolymers, ethylene/alpha-olefin copolymers having a density less than about 0.92 g/cm³, ethylene/methyl acrylate copolymers having a methyl acrylate content from about 20 to about 24 mol %, or ethylene/vinyl acetate copolymers having a vinyl acetate content from about 10 to about 30 mol %.

In one aspect of the invention, the particular shape, size and structure of the packages which can be made using the methods of the present invention will be governed by the type and size of the specific respiring food product to be packaged. In one embodiment of the present invention, the thermoplastic films may be formed as a bag. In another aspect of the present invention, the thermoplastic film may be tightly shrunk onto the cheese so as to attractively display the product.

Exemplary Packaged Cheeses

In one aspect, the present invention relates to a package comprising a bloomy rind cheese; and a thermoplastic film; wherein said cheese is enclosed in said film; and said film has a carbon dioxide transmission rate from about 7,500 cc/100 sq.in/day to about 11,000 cc/100 sq.in/day.

In one aspect, the present invention relates to a package comprising a bloomy rind cheese; and a thermoplastic film; wherein said cheese is enclosed in said film; and said film has an oxygen transmission rate from about 900 cc/100 sq.in/day to about 1,300 cc/100 sq.in/day.

In one aspect, the present invention relates to a package comprising a bloomy rind cheese; and a thermoplastic film; wherein said cheese is enclosed in said film; and said film has a water vapor transmission rate from about 17 g/100 sq.in/day at 100 F/90% RH to about 30 g/100 sq.in/day at 100 F/90% RH.

In one aspect, the present invention relates to a package comprising a bloomy rind cheese; and a thermoplastic film; wherein said cheese is enclosed in said film; said film has a carbon dioxide transmission rate from about 7,500 cc/100 sq.in/day to about 11,000 cc/100 sq.in/day; and said film has an oxygen transmission rate of about 1,030 cc/100 sq.in/day or about 1,100 cc/100 sq.in/day.

In one aspect, the present invention relates to a package comprising a bloomy rind cheese; and a thermoplastic film; wherein said cheese is enclosed in said film; said film has a carbon dioxide transmission rate from about 7,500 cc/100 sq.in/day to about 11,000 cc/100 sq.in/day; and said film has a water vapor transmission rate of about 19.1 g/100 sq.in/day at 100 F/90% RH or about 26.6 g/100 sq.in/day at 100 F/90% RH.

In one aspect, the present invention relates to a package comprising a bloomy rind cheese; and a thermoplastic film; wherein said cheese is enclosed in said film; said film has an oxygen transmission rate from about 900 cc/100 sq.in/day to about 1,300 cc/100 sq.in/day; and said film has a water vapor transmission rate of about 19.1 g/100 sq.in/day at 100 F/90% RH or about 26.6 g/100 sq.in/day at 100 F/90% RH.

In one aspect, the present invention relates to a package comprising a bloomy rind cheese; and a thermoplastic film; wherein said cheese is enclosed in said film; said film has a oxygen transmission rate from about 900 cc/100 sq.in/day to about 1,300 cc/100 sq.in/day; said film has an water vapor transmission rate of about 19.1 g/100 sq.in/day at 100 F/90% RH or about 26.6 g/100 sq.in/day at 100 F/90% RH; and said film has a carbon dioxide transmission rate of about 8,240 cc/100 sq.in/day or about 10,000 cc/100 sq.in/day.

In certain embodiments, the package of the present invention comprises a thermoplasmic film, wherein said film is 60 gauge or 65 gauge.

In certain embodiments, the package of the present invention comprises a thermoplasmic film, wherein said film is non-perforated.

In certain embodiments, said bloomy rind cheese is selected from the group consisting of brie, Brillat-Savarin Petit, Triple-creme, chaource, coulommiers, fromage, Pierre Robert, and camembert.

Exemplary Packaging Methods

In one aspect, the present invention relates to a method of packaging a respiring food product comprising wrapping said respiring food product with a thermoplastic film having a carbon dioxide transmission rate from about 7,500 cc/100 sq.in/day to about 11,000 cc/100 sq.in/day.

In one aspect, the present invention relates to a method of packaging a respiring food product comprising wrapping said respiring food product with a thermoplastic film having an oxygen transmission rate from about 900 cc/100 sq.in/day to about 1,300 cc/100 sq.in/day.

In one aspect, the present invention relates to a method of packaging a respiring food product comprising wrapping said respiring food product with a thermoplastic film having a water vapor transmission rate from about 17 g/100 sq.in/day at 100 F/90% RH to about 30 g/100 sq.in/day at 100 F/90% RH.

In one aspect, the present invention relates to a method of packaging a respiring food product comprising wrapping said respiring food product with a thermoplastic film having a carbon dioxide transmission rate from about 7,500 cc/100 sq.in/day to about 11,000 cc/100 sq.in/day, and an oxygen transmission rate from about 900 cc/100 sq.in/day to about 1,300 cc/100 sq.in/day.

In one aspect, the present invention relates to a method of packaging a respiring food product comprising wrapping said respiring food product with a thermoplastic film having a carbon dioxide transmission rate from about 7,500 cc/100 sq.in/day to about 11,000 cc/100 sq.in/day, and a water vapor transmission rate from about 17 g/100 sq.in/day at 100 F/90% RH to about 30 g/100 sq.in/day at 100 F/90% RH.

In one aspect, the present invention relates to a method of packaging a respiring food product comprising wrapping said respiring food product with a thermoplastic film having a water vapor transmission rate from about 17 g/100 sq.in/day at 100 F/90% RH to about 30 g/100 sq.in/day at 100 F/90% RH, and an oxygen transmission rate from about 900 cc/100 sq.in/day to about 1,300 cc/100 sq.in/day.

In one aspect, the present invention relates to a method of packaging a respiring food product comprising wrapping said respiring food product with a thermoplastic film having a carbon dioxide transmission rate from about 7,500 cc/100 sq.in/day to about 11,000 cc/100 sq.in/day, an oxygen transmission rate from about 900 cc/100 sq.in/day to about 1,300 cc/100 sq.in/day, and a water vapor transmission rate from about 17 g/100 sq.in/day at 100 F/90% RH to about 30 g/100 sq.in/day at 100 F/90% RH.

In certain embodiments, the present invention relates to any one of the aforementioned methods, wherein said film has a carbon dioxide transmission rate of about 8,240 cc/100 sq.in/day or about 10,000 cc/100 sq.in/day.

In certain embodiments, the present invention relates to any one of the aforementioned methods, wherein said film has an oxygen transmission rate of about 1,030 cc/100 sq.in/day or about 1,100 cc/100 sq.in/day.

In certain embodiments, the present invention relates to any one of the aforementioned methods, wherein said film has a water vapor transmission rates of about 19.1 g/100 sq.in/day at 100 F/90% RH or about 26.6 g/l 00 sq.in/day at 100 F/90% RH.

In certain embodiments, the present invention relates to any one of the aforementioned methods, wherein said film has a carbon dioxide transmission rate of about 8,240 cc/100 sq.in/day or about 10,000 cc/100 sq.in/day; and an oxygen transmission rate of about 1,030 cc/100 sq.in/day or about 1,100 cc/100 sq.in/day.

In certain embodiments, the present invention relates to any one of the aforementioned methods, wherein said film has a carbon dioxide transmission rate of about 8,240 cc/100 sq.in/day or about 10,000 cc/100 sq.in/day; and a water vapor transmission rates of about 19.1 g/100 sq.in/day at 100 F/90% RH or about 26.6 g/100 sq.in/day at 100 F/90% RH.

In certain embodiments, the present invention relates to any one of the aforementioned methods, wherein said film has an oxygen transmission rate of about 1,030 cc/100 sq.in/day or about 1,100 cc/100 sq.in/day; and a water vapor transmission rates of about 19.1 g/100 sq.in/day at 100 F/90% RH or about 26.6 g/100 sq.in/day at 100 F/90% RH.

In certain embodiments, the present invention relates to any one of the aforementioned methods, wherein said film has a carbon dioxide transmission rate of about 8,240 cc/100 sq.in/day or about 10,000 cc/100 sq.in/day; an oxygen transmission rate of about 1,030 cc/100 sq.in/day or about 1,100 cc/100 sq.in/day; and a water vapor transmission rates of about 19.1 g/100 sq.in/day at 100 F/90% RH or about 26.6 g/100 sq.in/day at 100 F/90% RH.

In certain embodiments, said film is 60 gauge or 65 gauge.

In certain embodiments said film is non-perforated.

In certain embodiments, said respiring food product is selected from the group consisting of processed meat, fresh meat, fish, natural cheese, vegetable, and fruit.

In certain embodiments, said respiring food product is natural cheese; and said natural cheese is selected from the group consisting of mold-ripened cheese, bloomy rind cheese, white mold rind cheese, emmental cheese, Jarlsberg, edamer cheese, butterkase cheese, gouda, swiss, edam, camembert, brie, triple-creme, Brillat-Savarin, Pierre Robert, chaource, coulommiers, fromage, hard-grating, parmesan, hard cheese, appenzeller, cheddar, semisoft cheese, munster, roquefort, limburger, soft-ripened, cottage cheese, washed rind cheeses, blue cheese, Vacherin du Haut-Doubs cheese, Chèvre-Boîte, stilton, gorgonzola, gruyere, herregaardsost, danbo, asiago, viereckhartkase, bergkase, samsoe, cheshire, maribo, svecia, manchego, provolone, fontina, raclette, trappist, tilsit, havarti, cantal, St. Paulin, and feta.

In certain embodiments, said respiring food product is natural cheese; and said natural cheese is a bloomy rind cheese selected from the group consisting of brie, Brillat-Savarin Petit, Triple-crème, chaource, coulommiers, fromage, Pierre Robert, and camembert.

### INCORPORATION BY REFERENCE

All of the patents and publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A package, comprising a bloomy rind cheese; and a thermoplastic film; wherein said cheese is enclosed in said film; and said film has a carbon dioxide transmission rate from about 7,500 cc/100 sq.in/day to about 11,000 cc/100 sq.in/day.

2. A package, comprising a bloomy rind cheese; and a thermoplastic film; wherein said cheese is enclosed in said film; and said film has an oxygen transmission rate from about 900 cc/100 sq.in/day to about 1,300 cc/100 sq.in/day.

3. A package, comprising a bloomy rind cheese; and a thermoplastic film; wherein said cheese is enclosed in said film; and said film has a water vapor transmission rate from about 17 g/100 sq.in/day at 100 F/90% RH to about 30 g/100 sq.in/day at 100 F/90% RH.

4. The package of claim 1, wherein said film has an oxygen transmission rate of about 900 cc/100 sq.in/day to about 1,300 cc/100 sq.in/day.

5. The package of claim 1, wherein said film has a water vapor transmission rates of about 17 g/100 sq.in/day at 100 F/90% RH to about 30 g/100 sq.in/day at 100 F/90% RH.

6. The package of claim 2, wherein said film has a water vapor transmission rate of about 17 g/100 sq.in/day at 100 F/90% RH to about 30 g/100 sq.in/day at 100 F/90% RH.

7. The package of claim 6, wherein said film has a carbon dioxide transmission rate of about 7,500 cc/100 sq.in/day to about 11,000 cc/100 sq.in/day.

8. The package of claim 7, wherein said film has a carbon dioxide transmission rate of about 8,240 cc/100 sq.in/day or about 10,000 cc/100 sq.in/day.

9. The package of claim 7, wherein said film has an oxygen transmission rate of about 1,030 cc/100 sq.in/day or about 1,100 cc/100 sq.in/day.

10. The package of claim 7, wherein said film has a water vapor transmission rates of about 19.1 g/100 sq.in/day at 100 F/90% RH or about 26.6 g/100 sq.in/day at 100 F/90% RH.

11. The package of claim 7, wherein said film has a carbon dioxide transmission rate of about 8,240 cc/100 sq.in/day or about 10,000 cc/100 sq.in/day; and an oxygen transmission rate of about 1,030 cc/100 sq.in/day or about 1,100 cc/100 sq.in/day.

12. The package of claim 7, wherein said film has a carbon dioxide transmission rate of about 8,240 cc/100 sq.in/day or about 10,000 cc/100 sq.in/day; and a water vapor transmission rates of about 19.1 g/100 sq.in/day at 100 F/90% RH or about 26.6 g/100 sq.in/day at 100 F/90% RH.

13. The package of claim 7, wherein said film has an oxygen transmission rate of about 1,030 cc/100 sq.in/day or about 1,100 cc/100 sq.in/day; and a water vapor transmission rates of about 19.1 g/100 sq.in/day at 100 F/90% RH or about 26.6 g/100 sq.in/day at 100 F/90% RH.

14. The package of claim 7, wherein said film has a carbon dioxide transmission rate of about 8,240 cc/100 sq.in/day or about 10,000 cc/100 sq.in/day; an oxygen transmission rate of about 1,030 cc/100 sq.in/day or about 1,100 cc/100 sq.in/day; and a water vapor transmission rates of about 19.1 g/100 sq.in/day at 100 F/90% RH or about 26.6 g/100 sq.in/day at 100 F/90% RH.

15. The package of claim 7, wherein said film is 60 gauge or 65 gauge.

16. The package of claim 7, wherein said film is non-perforated.

17. The package of claim 7, wherein said bloomy rind cheese is selected from the group consisting of brie, Brillat-Savarin Petit, Triple-crème, chaource, coulommiers, fromage, Pierre Robert, and camembert.

18. A method of packaging a respiring food product, comprising wrapping said respiring food product with a thermoplastic film; wherein said film has a carbon dioxide transmission rate from about 7,500 cc/100 sq.in/day to about 11,000 cc/100 sq.in/day, an oxygen transmission rate from about 900 cc/100 sq.in/day to about 1,300 cc/100 sq.in/day, and a water vapor transmission rate from about 17 g/100 sq.in/day at 100 F/90% RH to about 30 g/100 sq.in/day at 100 F/90% RH.

19. The method of claim 18, wherein said film is 60 gauge or 65 gauge.

20. The method of claim 18, wherein said respiring food product is selected from the group consisting of processed meat, fresh meat, fish, natural cheese, vegetable, and fruit.

21. The method of claim 18, wherein said respiring food product is natural cheese; and said natural cheese is selected from the group consisting of mold-ripened cheese, bloomy rind cheese, white mold rind cheese, emmental cheese, Jarlsberg, edamer cheese, butterkase cheese, gouda, swiss, edam, camembert, brie, triple-crème, Brillat-Savarin, Pierre Robert, chaource, coulommiers, fromage, hard-grating, parmesan, hard cheese, appenzeller, cheddar, semisoft cheese, munster, roquefort, limburger, soft-ripened, cottage cheese, washed rind cheeses, blue cheese, Vacherin du Haut-Doubs cheese, Chèvre-Boîte, stilton, gorgonzola, gruyere, herregaardsost, danbo, asiago, viereckhartkase, bergkase, samsoe, cheshire, maribo, svecia, manchego, provolone, fontina, raclette, trappist, tilsit, havarti, cantal, St. Paulin, and feta.

22. The method of claim 18, wherein said respiring food product is natural cheese; and said natural cheese is a bloomy rind cheese selected from the group consisting of brie, Brillat-Savarin Petit, Triple-crème, chaource, coulommiers, fromage, Pierre Robert, and camembert.
